(19) United States
(12) Patent Application Publication
(10) Pub. No.: US 2024/0317446 A1
(43) Pub. Date: Sep. 26, 2024

(54) LABEL APPLICATOR

(71) Applicant: Innotek Corporation, Maple Grove, MN (US)

(72) Inventors: Anthony Vessels, Ham Lake, MN (US); Troy Sarkinen, Howard Lake, MN (US)

(21) Appl. No.: 18/598,449

(22) Filed: Mar. 7, 2024

Related U.S. Application Data
(60) Provisional application No. 63/454,391, filed on Mar. 24, 2023.

(51) Int. Cl. B65C 9/36

(52) U.S. Cl. CPC B65C 9/36

(57) ABSTRACT

A labeler for applying labels to objects includes a tamp pad, a drive mechanism, a vacuum port and a tube. The tamp pad includes a surface configured to engage a label, and one or more openings into the surface. The drive mechanism drives the tamp pad between retracted and extended positions. The tube couples the tamp pad to the vacuum port. A length of the tube increases and decreases as the tamp pad is driven between the retracted and extended positions.

### CROSS-REFERENCE TO RELATED APPLICATION

This application claims the benefit of Provisional Application No. 63/454,391, filed Mar. 24, 2023, which is incorporated herein by reference in its entirety for all purposes.

### FIELD

The disclosure relates generally to devices for applying labels to objects such as packages.

### BACKGROUND

Label applicators or labelers are generally known and commercially available. These devices apply labels to objects such as packages or envelopes, and may be used in connection with printers that print information, such as addresses or other identifying information, on the labels. The Dods U.S. Pat. No. 6,845,800 and the Schaller U.S. Pat. No. 7,462,252, for example, disclose labels with tamp pads.

There remains a continuing need for improved label applicators or labelers. In particular, there is a need for improved labelers that can effectively and efficiently apply labels at relatively high speeds.

### SUMMARY

Disclosed embodiments include a labeler that can effectively and efficiently apply labels to objects such as packages or envelopes at relatively high speeds. Embodiments include a linear tamp for applying labels to the objects.

In embodiments, a DC servo motor drives a belt style linear actuator. A DC fan mounted to the stationary portion of the tamp creates enough low pressure inside the vacuum chamber to hold labels onto the tamp pad during the cycle. The vacuum chamber includes a fan housing, inner vacuum tube, outer vacuum tube, and vacuum/tamp pad. Upon servo motor actuation, the outer vacuum tube along with the vacuum/tamp pad extend out. The vacuum fan keeps constant low pressure on the inside of the vacuum chamber as the outer vacuum tube slides out.

Embodiments may include a guide rod to act as a linear guide to stabilize tamp upon extension. Embodiments may also include an e-chain that allows conductors to be run in a contained manner through the tamp. The tamp pad may be attached to a flexible mount, such as for example a gimbal. Embodiments may include a sensor, such as for example on the tamp pad or flexible mount, to detect when the tamp pad makes contact with the object being labeled. The sensor may be coupled to a controller, and may indicate when the label has been “placed.” Embodiments may also include a sensor, such as for example a “home” sensor coupled to the controller, that detects a return of the tamp pad to its retracted or home position, thereby indicating that the labeler is ready to accept another label.

The telescopic inner and outer vacuum tube design allows the vacuum fan to remain stationary. This allows the vacuum to be conveyed ‘remotely’ to the pad during a tamp cycle. In some embodiments, the tamp cycle may be performed without electronic or pneumatic components on the moving members of the tamp. This eliminates or reduces the need for specialized conductors and conductor carriers. This may also enable electronic components to remain stationary which may help prolong lifespan.

Food and beverage, industrial, pharmaceutical, consumer products, automotive, aerospace, ecommerce, and any other industry that requires labels to be placed on packaging may use the labeler. Embodiments of the labeler may be configured to mount to printers that print information on the labels.

### BRIEF DESCRIPTION OF THE DRAWINGS

FIG. 1 is a diagrammatic illustration of a print and apply labeler system including a label applicator or labeler, in accordance with embodiments.

FIG. 2 is a plan view of a labeler in accordance with embodiments.

FIG. 3 is a sectional view of the labeler shown in FIG. 2, taken along lines 3-3 in FIG. 2.

FIG. 4 is an end view of the labeler showing the tamp pad, in accordance with embodiments.

FIGS. 5A and 5B are illustrations of a tube that can be incorporated into the labeler, in accordance with embodiments.

FIG. 6 is an engineering drawing including annotated illustrations of a labeler in accordance with embodiments.

### DETAILED DESCRIPTION

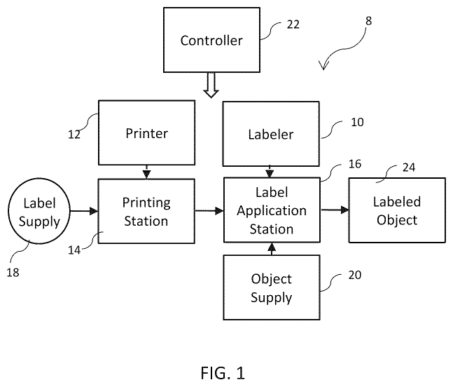

FIG. 1 is a diagrammatic illustration of a print and apply label system 8 including a label applicator or labeler 10 in accordance with embodiments. As shown, in addition to the labeler 10, the system 8 may include one or more of a printer 12, printing station 14, label application station 16, label supply 18 and object supply 20. A controller 22 can be coupled to components of the system 8 such as labeler 10, printer 12, label supply 18 and/or object supply 20. Print and apply label systems such as 8 are generally known and commercially available, and are disclosed, for example, in the Dods U.S. Pat. No. 6,845,800 and the Schaller U.S. Pat. No. 7,462,252, both of which are incorporated herein by reference in their entireties and for all purposes.

Print and apply label system 8 is controlled by the controller 22. Labels (not separately shown) from the label supply 18 are moved to the printing station 14, where they are printed by the printer 12. Any of a wide range of information can be printed on the labels at the printing station 14. Nonlimiting examples of information that can be printed by the printer 12 include addresses, object or product information, bar codes including information and/or QR codes including information. At the label application station 16 the printed labels received from the printing station 14 are applied to objects (not separately shown) by the labeler 10. The objects, which as nonlimiting examples can include packages or envelopes, may be received from the object supply 20. A labeled object 24 that is labeled by the print and apply label system 8 is also shown in FIG. 1 for purposes of example.

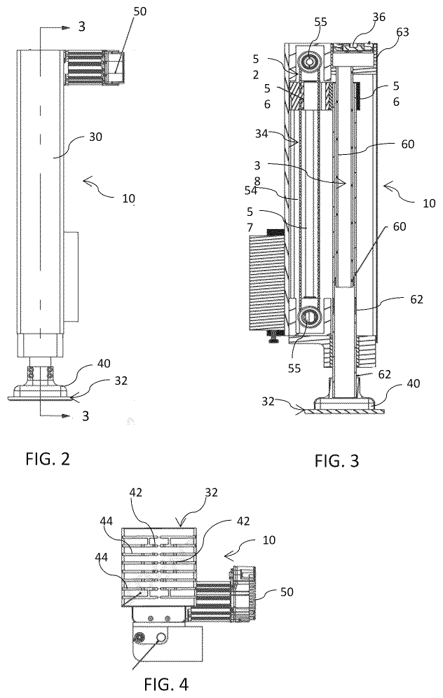

An exemplary labeler 10 in accordance with embodiments is shown in FIGS. 2-4. As shown, the labeler 10 includes a housing 30, tamp pad 32, drive mechanism 34, vacuum source 36, and a tube 38 coupling the tamp pad to the vacuum source. The tamp pad 32 is mounted to a bottom side of a chamber housing 40 that defines an interior chamber. The chamber housing 40 is mounted to an end of the tube 38. As perhaps best shown in FIG. 4, an outer surface of the tamp pad 32, i.e., the surface opposite the chamber housing 40, includes one or more openings 42 that extend through the tamp pad and into communication with the interior chamber of the chamber housing 40. The embodiments of tamp pad 32 shown in FIG. 4 have a plurality of openings. Other embodiments of tamp pad 32 may have more or fewer openings 42. The illustrated embodiments of tamp pad 32 also have a plurality of recesses or channels 44 in the outer surface that are in communication with one or more of the openings 42. Other embodiments of tamp pad 32 have more or fewer (or no) channels 44, and the channels may have configurations different than the configurations shown in FIG. 4.

The drive mechanism 34 is configured to reciprocally drive the tamp pad 32 between extended and retracted positions to apply the labels to the objects at the label application station 16. In the illustrated embodiments, the drive mechanism 34 includes a servo motor 50 coupled to a belt drive 52. Belt drive 52 includes a belt 54 that extends between two spaced-apart pulleys 55. The drive mechanism 34 also includes a carriage or coupler 56 that couples the belt 54 to the tamp pad 32. In the illustrated embodiment, the coupler 56 is mounted for sliding motion to a shaft 57 that guides the coupler as it is moved by the belt 54. The servo motor 50, which may be controlled by a controller such as 22 (FIG. 1), actuates the belt drive 52 in a manner that causes the belt drive, via the coupler 56, to drive the tamp pad 32 between extended and retracted positions (e.g., up and down in the embodiments shown in FIGS. 2 and 3) while applying labels to objects at the label application station 16. In the embodiments shown in FIGS. 2 and 3, the drive mechanism 34 is coupled to the tamp pad 32 via the tube 38 by the coupler 56 that extends between the belt 54 and the tube 38. In other embodiments, the drive mechanism 34 is coupled directly to the tamp pad 32, or to other structures such as the chamber housing 40 to which the tamp pad is attached.

During operation of the labeler 10, labels, e.g., received from the printing station 14, for application to an object are held or retained on the outer surface of the tamp pad 32 by relatively low pressure, such as a vacuum, applied through the one or more openings 42 and any channels 44 in the surface of the tamp pad. The vacuum source 36, which for purposes of example is shown as a fan in FIG. 3, is supported in a housing 63 mounted to the housing 30. The relatively low pressure or vacuum applied to the surface of the tamp pad 32 for this purpose is received at a vacuum port on the labeler 10, and generated by a vacuum source such as the fan 36. The vacuum is coupled from the vacuum port to the chamber housing 40 by the tube 38. In the illustrated embodiments, the fan 36 on the housing 30 of the labeler 10 functions as the vacuum source, and the vacuum port may be the portion of the tube 38 to which the vacuum generated by the fan is coupled. Other embodiments of the labeler 10 make use of a vacuum source (e.g., a fan) remote from the labeler 10, and the remote vacuum source is coupled to the vacuum port, such as an end of the tube 38, by other structures such as a vacuum hose or tube.

In the embodiments shown in FIGS. 2 and 3, the tamp pad 32 is driven along a generally linear path between its extended and retracted positions. The tube 38 that couples the vacuum port to the tamp pad 32 expands and retracts in length, e.g., its length increases and decreases, as the tamp pad moves between extended and retracted positions. The tube 38 remains generally linear during the movement between the extended and retracted positions.

Tube 38 is a telescoping tube in the illustrated embodiments, and includes a first tube section 60 and a second tube section 62. In the illustrated embodiments, the first tube section 60 is fixedly mounted with respect to the housing 63 of the labeler 10, and remains stationary as the tamp pad 32 is driven between the extended and retracted positions. A proximal end of the first tube section 60 is coupled to the fan 36, and effectively functions as the vacuum port. Second tube section 62 is configured to move back and forth with respect to the first tube section 60, and is mounted coaxially and on the outside of the first tube section in the illustrated embodiments. The distal end of the second tube section 62 is coupled to the chamber housing 40 in the illustrated embodiments. In these embodiments, the coupler 56 of the drive mechanism 34 is coupled to the second tube section 62. The drive mechanism 34 thereby drives the second tube section 62 back and forth with respect to the first tube section 60 to drive the tamp pad 32 between its extended and retracted positions while coupling the vacuum from the vacuum port to the tamp pad.

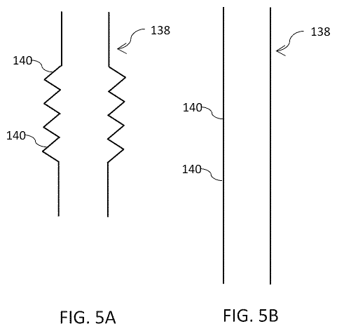

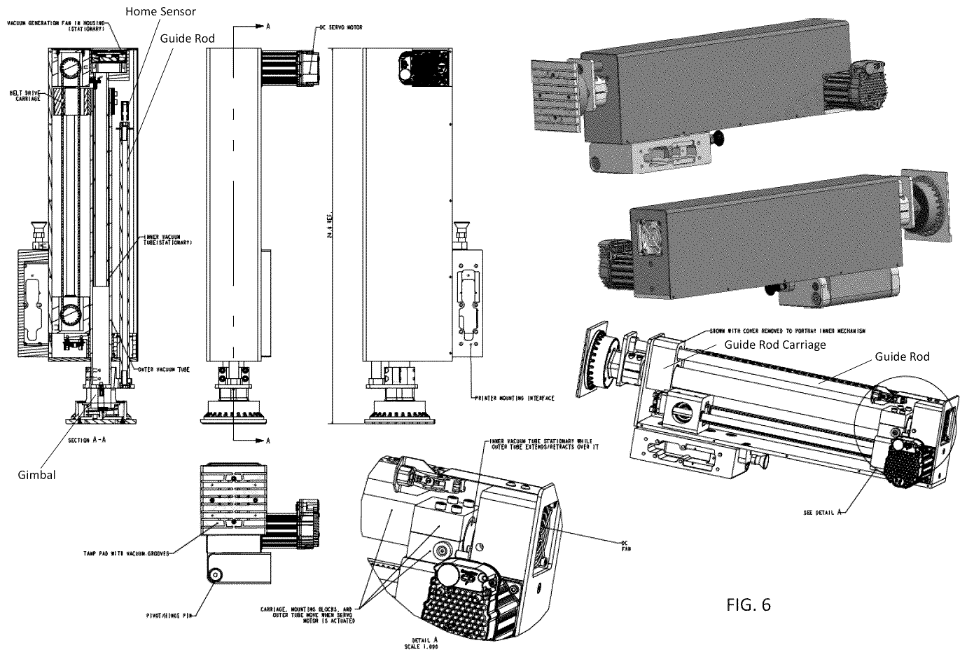

FIGS. 5A and 5B are illustrations of a tube 138 that can be used in place of the tube 38 in accordance with other embodiments of the labeler 10. FIG. 5A shows the tube 138 in a retracted or decreased length state, and FIG. 5B shows the tube in an extended or increased length state. As shown, the tube 138 includes longitudinally or lengthwise extendable/collapsible sections 140 that facilitate the ability of tube 138 to extend and retract. All or portions of the extendable/collapsible sections 140 may be flexible to provide the tube 138 with the capability of extending and retracting. In embodiments, the tube 138 retains its generally linear configuration as it transitions between its increased and decreased length state.

Yet other embodiments of the labeler 10 include other tubes that couple the vacuum port to the tamp pad 32, and that are capable of increasing and decreasing in length. For example, such tubes may be formed from stretchable and resilient material.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A labeler for applying labels to objects, including:
a tamp pad including a surface configured to engage a label, wherein the tamp pad includes one or more openings into the surface;
a drive mechanism to drive the tamp pad between retracted and extended positions;
a vacuum port; and
a tube coupling the tamp pad to the vacuum port, wherein a length of the tube increases and decreases as the tamp pad is driven between the retracted and extended positions.

2. The labeler of claim 1, wherein the tube is generally linear.

3. The labeler of claim 1, wherein the tube comprises a telescoping tube.

4. The labeler of claim 3, wherein the telescoping tube includes first and second tubular members telescopically mounted with respect to one another.

5. The labeler of claim 1, further comprising a chamber housing coupling the tube to the tamp pad.

6. The labeler of claim 1, further comprising a drive mechanism configured to drive the tamp pad between the retracted and extended positions.

7. The labeler of claim 6, wherein the drive mechanism is coupled to the tube.

8. The labeler of claim 6, wherein the drive mechanism is coupled to the tamp pad.

9. The labeler of claim 1, wherein the tube remains generally linear as its length increases and decreases.

10. A labeler for applying labels to objects, including:
a tamp pad including a surface configured to engage a label, wherein the tamp pad includes one or more openings into the surface;
a drive mechanism to drive the tamp pad between retracted and extended positions;
a vacuum port;
a linear tube coupling the tamp pad to the vacuum port, wherein a length of the tube increases and decreases as the tamp pad is driven between the retracted and extended positions, wherein the tube remains linear as its length increases and decreases;
a chamber housing coupling the tube to the tamp pad; and
a drive mechanism configured to drive the tamp pad between the retracted and extended positions.
